(19) United States
(12) Patent Application Publication
(10) Pub. No.: US 2025/0088227 A1
(43) Pub. Date: Mar. 13, 2025

(54) PRECODING METHOD, COMMUNICATION APPARATUS, AND STORAGE MEDIUM

(71) Applicant: Beijing Xiaomi Mobile Software Co., Ltd., Beijing (CN)

(72) Inventors: Liangang CHI, Beijing (CN); Li YANG, Beijing (CN)

(73) Assignee: Beijing Xiaomi Mobile Software Co., Ltd., Beijing (CN)

(21) Appl. No.: 18/726,647

(22) PCT Filed: Jan. 7, 2022
(86) PCT No.: PCT/CN2022/070853

§ 371 Date: Jul. 5, 2024

(51) Int. Cl. H04B 7/0456; H04B 7/04

(52) U.S. Cl. CPC H04B 7/0456; H04B 7/04013

(57) ABSTRACT

Processing methods and apparatuses, communication apparatuses, and storage mediums are provided for precoding information to improve service quality in a wireless communication system. The service quality is improved by: Precoding information sent by a network-side device is obtained, an incident beam is precoded based on the precoding information to form a composite beam, and the composite beam is emitted. The provided methods can reduce the complexity of precoding.

### CROSS-REFERENCE TO RELATED APPLICATIONS

The present disclosure is a U.S. national phase of PCT Application No. PCT/CN2022/070853 filed on Jan. 7, 2022, the content of which is hereby incorporated by reference in its entirety.

### TECHNICAL FIELD

The present disclosure relates to a field of communication technology, and in particular, to precoding methods and apparatuses, communication apparatuses, and storage mediums.

### BACKGROUND

In a wireless communication system, to improve service quality, by introducing a precoding technology, an incident signal transmitted from a base station to an RIS (reconfigurable intelligent surface) or a smart repeater is reflected to UE (user equipment) in a specific direction, to construct an intelligent programmable wireless environment, thereby enhancing a signal strength of a signal received at a side of the UE and implementing a channel control.

### SUMMARY

The present disclosure provides precoding methods and apparatuses, communication apparatuses, and storage mediums.

An embodiment in an aspect of the present disclosure provides a precoding method that is applied to an assistance communication device and includes:
obtaining precoding information sent by a network-side device; and
precoding, based on the precoding information, an incident beam to form a composite beam, and emitting the composite beam.

An embodiment in an aspect of the present disclosure provides a precoding method that is applied to a network-side device and includes:
obtaining PMI information from at least two UE;
determining precoding information based on the PMI information; and
sending the precoding information to an assistance communication device.

An embodiment in an aspect of the present disclosure provides a precoding method that is applied to UE and includes:
sending PMI information to a network-side device.

An embodiment in yet another aspect of the present disclosure provides a communication apparatus. The apparatus includes a processor and a memory. The memory stores a computer program, and the processor, when executing the computer program stored in the memory, causes the apparatus to execute the method provided in the embodiment in the above aspect.

An embodiment in yet another aspect of the present disclosure provides a communication apparatus. The apparatus includes a processor and a memory. The memory stores a computer program, and the processor, when executing the computer program stored in the memory, causes the apparatus to execute the method provided in the embodiment in the above aspect.

An embodiment in yet another aspect of the present disclosure provides a communication apparatus. The apparatus includes a processor and a memory. The memory stores a computer program, and the processor, when executing the computer program stored in the memory, causes the apparatus to execute the method provided in the embodiment in the above another aspect.

An embodiment in yet another aspect of the present disclosure provides a computer-readable storage medium, configured to store instructions. When the instructions are executed, the method provided in the embodiment of the above aspect is implemented.

An embodiment in yet another aspect of the present disclosure provides a computer-readable storage medium, configured to store instructions. When the instructions are executed, another aspect of the method provided in the embodiment of the above is implemented.

An embodiment in yet another aspect of the present disclosure provides a computer-readable storage medium, configured to store instructions. When the instructions are executed, another aspect of the method provided in the embodiment of the above is implemented.

### BRIEF DESCRIPTION OF DRAWINGS

The above and/or additional aspects and advantages of the present disclosure will become apparent and readily understood from the following description of embodiments in conjunction with the accompanying drawings.

FIG. 1 is a schematic flowchart of a precoding method provided by an embodiment of the present disclosure.

FIG. 2 is a schematic flowchart of a precoding method provided by another embodiment of the present disclosure.

FIG. 3 is a schematic flowchart of a precoding method provided by still another embodiment of the present disclosure.

FIG. 4 is a schematic flowchart of a precoding method provided by yet another embodiment of the present disclosure.

FIG. 5 is a schematic flowchart of a precoding method provided by yet another embodiment of the present disclosure.

FIG. 6 is a schematic flowchart of a precoding method provided by yet another embodiment of the present disclosure.

FIG. 7 is a schematic flowchart of a precoding method provided by yet another embodiment of the present disclosure.

FIG. 8 is a schematic flowchart of a precoding method provided by yet another embodiment of the present disclosure.

FIG. 9 is a schematic flowchart of a precoding method provided by yet another embodiment of the present disclosure.

FIG. 10 is a schematic structural diagram of a precoding apparatus provided by an embodiment of the present disclosure.

FIG. 11 is a schematic structural diagram of a precoding apparatus provided by another embodiment of the present disclosure.

FIG. 12 is a schematic structural diagram of a precoding apparatus provided by still another embodiment of the present disclosure.

FIG. 13 is a block diagram of user equipment provided by an embodiment of the present disclosure.

FIG. 14 is a block diagram of a network-side device provided by an embodiment of the present disclosure.

### DETAILED DESCRIPTION

Exemplary embodiments will be described in details herein, with examples thereof represented in the accompanying drawings. When the following description involves the accompanying drawings, same numerals in different figures represent same or similar elements unless otherwise indicated. Implementations described in the following exemplary embodiments do not represent all implementations consistent with embodiments of the present disclosure. On the contrary, they are only examples of apparatuses and methods that are consistent with some aspects of embodiments of the present disclosure as detailed in the attached claims.

Terms used in the embodiments of the present disclosure are only for a purpose of describing specific embodiments, and are not intended to limit the embodiments of the present disclosure. Singular forms, “a/an” and “the” used in the embodiments and the appended claims of the present disclosure are also intended to include majority forms, unless the context clearly indicates other meanings. It should also be understood that the term “and/or” used herein refers to and includes any or all possible combinations of one or more related listed items.

It should be understood that although terms, such as “first,” “second,” “third,” etc., may be used in the embodiments of the present disclosure to describe various information, such information should not be limited by these terms. These terms are only used to distinguish a same type of information from each other. For example, without departing from the scope of the embodiments of the present disclosure, first information may also be referred to as second information, and similarly, the second information may also be referred to as the first information. Depending on the context, terms “if” and “in case of” used herein may be interpreted as “when,” “while,” or “in response to determining.”

In a related technology, the precoding of the smart repeater/RIS and the precoding of the base station are jointly designed mainly by an alternate optimization technology. However, in the related technology, when the precoding of the smart repeater/RIS and the precoding of the base station are jointly designed by the alternate optimization technology, different algorithms need to be separately used, resulting in too high complexity.

Precoding methods and apparatuses, communication apparatuses, and storage mediums provided by the embodiments of the present disclosure will be described in detail below with reference to the accompanying drawings.

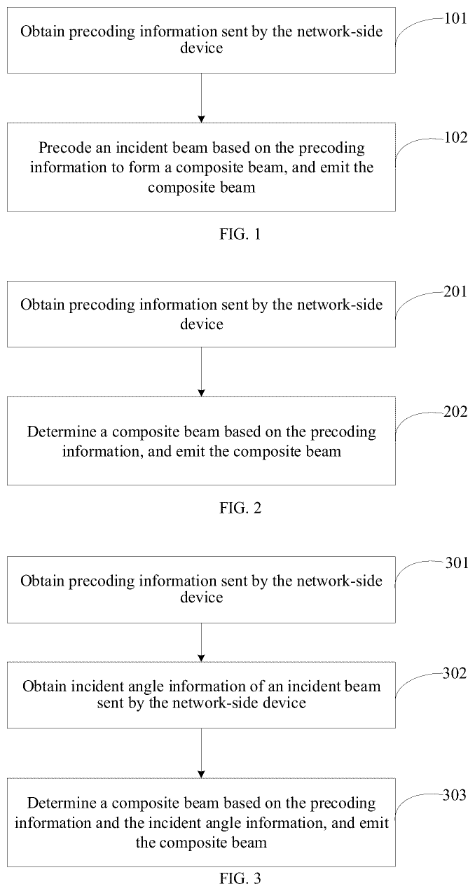

FIG. 1 is a schematic flowchart of a precoding method provided by an embodiment of the present disclosure. The method provided by the embodiment of the present disclosure may be applied to a multi-UE scenario, and the method is executed by an assistance communication device. As shown in FIG. 1, the precoding method may include the following steps 101-102.

At step 101, precoding information sent by the network-side device is obtained.

In an embodiment of the present disclosure, the above assistance communication device may be a smart repeater and/or an RIS array.

In an embodiment of the present disclosure, the precoding information may include at least one of:
at least one specific PMI (precoding matrix index); or
a weighting coefficient set for each of the at least one specific PMI; where the weighting coefficient set for each of the at least one specific PMI includes at least one weighting coefficient and is determined by at least one weighting coefficient corresponding to the each specific PMI and at least one UE.

It should be noted that, in an embodiment of the present disclosure, the above precoding information may be determined by the network-side device based on PMI information from at least two UE. That is, the precoding information may be determined by the network-side device according to the PMI information of the at least two UE. In an embodiment of the present disclosure, there may be a plurality of pieces of the PMI information, where the plurality of pieces of the PMI information may correspond to two or more UE, where one UE may correspond to one or more pieces of the PMI information. In an embodiment of the present disclosure, the PMI information of the at least two UE includes PMIs sent by the at least two UE. Further, the PMI information of the at least two UE may further include a weighting coefficient corresponding to each of the PMIs and each of the at least two UE. The PMIs include M PMIs with best channel quality and/or N PMIs with worst channel quality corresponding to the UE, where M and N are integers greater than or equal to 0. In addition, the weighting coefficient corresponding to the PMI is positively correlated with a bias degree of a composite beam, obtained by precoding the incident beam with the PMI, relative to the UE. For example, a precoding codebook includes N precoding matrices; the UE calculates an optimal beam precoding matrix W, and approximates the optimal beam precoding matrix W by using a linear combination of X precoding matrices in the codebook, where the weighting coefficient is a weighting coefficient of the linear combination. In a possible example, it is assumed that there are 10 candidate precoding matrices (X=10), and the optimal beam precoding matrix calculated by the UE is not in the candidate precoding matrices. Therefore, all or a part of the 10 candidate precoding matrices (several candidate precoding matrices closer to the optimal beam precoding matrix) may be used for approximation, to determine weighting coefficients of the candidate precoding matrices; that is, the closer a candidate precoding matrix approximates the optimal beam precoding matrix, and the higher a weighting coefficient of the candidate precoding matrix is.

In addition, in an embodiment of the present disclosure, the above PMI information may be directly sent by the UE to the network-side device; in another embodiment of the present disclosure, the above PMI information may be forwarded by the assistance communication device from the UE to the network-side device, that is, the UE first sends the PMI information to the assistance communication device, and then the assistance communication device forwards the PMI information to the network-side device. In the embodiment of the present disclosure, the assistance communication device may be for example a smart repeater/RIS.

In addition, in an embodiment of the present disclosure, when the UE sends the PMIs in the PMI information, the UE may sequentially send the PMIs in a specific order. In an embodiment of the present disclosure, the specific order may be an order of the PMIs from small to large. In another embodiment of the present disclosure, the specific order may be an order of channel quality corresponding to the PMIs from best to worst. In yet another embodiment of the present disclosure, the specific order may be an order of the channel quality corresponding to the PMIs from worst to best. Certainly, the PMI information sent by the UE may include one or more PMIs. If the UE sends only one PMI, there is no need to order the PMI; and if the UE sends a plurality of PMIs, the UE may order the PMIs in the above manner or any possible manner.

Exemplarily, in an embodiment of the present disclosure, it is assumed that PMI information sent by certain UE to the network-side device includes two PMIs that are respectively a PMI-1 with worst channel quality and a PMI-2 with best channel quality corresponding to the UE. In this case, the order in which the UE sends the two PMIs may be the order of the PMIs from small to large, that is, sequentially sending the PMI-1 and the PMI-2; or the order in which the UE sends the two PMIs may be the order of channel quality corresponding to the PMIs from best to worst, that is, sequentially sending the PMI-2 and the PMI-1; or the order in which the UE sends the two PMIs may be the order of the channel quality corresponding to the PMIs from worst to best, that is, sequentially sending the PMI-1 and the PMI-2.

It should be further noted that in an embodiment of the present disclosure, the above weighting coefficient corresponding to the PMI and the UE is an optional option, that is, the UE may send each PMI sent by the UE, and the weighting coefficient corresponding to each PMI of the UE and the UE to the network-side device; or the UE may not send the weighting coefficient corresponding to each PMI of the UE and the UE to the network-side device, but only send the PMIs to the network-side device. As described above, the weighting coefficient corresponding to each PMI of the UE and the UE, that is, the weighting coefficient corresponding to the PMI, is positively correlated with the bias degree of the composite beam, obtained by precoding the incident beam with the PMI, relative to the UE corresponding to the PMI.

In an embodiment of the present disclosure, the precoding information may be determined as follows. The network-side device selects at least one specific PMI from all PMIs corresponding to the obtained PMI information sent by the at least two UE, and determines a weighting coefficient set for each of the at least one specific PMI based on one or more weighting coefficients corresponding to the at least one specific PMI; and then, the network-side device determines the at least one specific PMI and/or the weighting coefficient set for each of the at least one specific PMI as the precoding information. The weighting coefficient set includes at least one weighting coefficient, and the weighting coefficient set for the each specific PMI is determined by at least one weighting coefficient corresponding to the each specific PMI and at least one UE. In the embodiment of the present disclosure, for each PMI, different UE corresponds to different weighting coefficients; and a weighting coefficient set for the PMI may be generated according to weighting coefficients corresponding to all or a part of the UE.

It should be noted that in an embodiment of the present disclosure, when selecting a specific PMI, the specific PMI is mainly determined based on target UE corresponding to the assistance communication device, where the target UE is UE that is to receive a composite beam obtained after the assistance communication device reflects and/or transilluminates an incident beam. In addition, the selected specific PMI should satisfy the following condition that after the incident beam is precoded by using the specific PMI to obtain the composite beam, the composite beam can be accurately received by the target UE.

Based on this, the specific PMI may include at least one of:
at least one PMI with best channel quality corresponding to the target UE; or
at least one PMI with worst channel quality corresponding to non-target UE.

In addition, it should be noted that in an embodiment of the present disclosure, after a specific PMI is determined, weighting coefficients of all UE corresponding to the specific PMI may be directly determined as a weighting coefficient set of the specific PMI. In another embodiment of the present disclosure, after determining the specific PMI, the network-side device may further change the weighting coefficient corresponding to the specific PMI, and determine the changed weighting coefficient as the weighting coefficient set of the specific PMI.

Exemplarily, in an embodiment of the present disclosure, it is assumed that there are two UE currently that is UE-1 and UE-2 respectively, where PMI information sent by the UE-1 to the base station includes: PMI-1 with best channel quality, a weighting coefficient a corresponding to the PMI-1, PMI-2 with worst channel quality, and a weighting coefficient b corresponding to the PMI-2; PMI information sent by the UE-2 to the base station includes: PMI-3 with worst channel quality, PMI-4 with best channel quality, a weighting coefficient c corresponding to the PMI-3, and a weighting coefficient d corresponding to the PMI-4. If the target UE is the UE-1, the network-side device may determine the PMI-1 and the PMI-3 as specific PMIs, and may determine the weighting coefficient a as a weighting coefficient set of the specific PMI-1 and determine the weighting coefficient c as a weighting coefficient set of the specific PMI-3.

Then, by executing the above steps, the network-side device may determine the precoding information and send the precoding information to the assistance communication device.

It should be noted that in an embodiment of the present disclosure, when sending the precoding information to the assistance communication device, the network-side device may optionally send a weighting coefficient set for a specific PMI or weighting coefficient sets corresponding to a part of specific PMIs to the assistance communication device; that is, the network-side device may send the weighting coefficient set for each specific PMI to the assistance communication device, or the network-side device may not send the weighting coefficient set for each specific PMI to the assistance communication device, but only send one specific PMI or several specific PMIs.

At step 102, an incident beam is precoded based on the precoding information to form a composite beam, and the composite beam is emitted.

In an embodiment of the present disclosure, precoding, by the assistance communication device, the incident beam based on the precoding information may specifically include: determining the composite beam based on a specific PMI and/or a weighting coefficient set for the specific PMI. In a possible implementation, the incident beam may be reflected and/or transilluminated in a specific direction based on the specific PMI and/or the weighting coefficient set for the specific PMI, to obtain the composite beam.

Further, the method may further include: emitting the composite beam to the UE. Specifically, the network device may emit the composite beam to one UE, or may emit the composite beam to a plurality of UE devices.

In summary, in the precoding method provided by the embodiment of the present disclosure, the assistance communication device obtains the precoding information sent by the network-side device, then precodes the incident beam based on the precoding information to form the composite beam, and emits the composite beam. Therefore, in the embodiment of the present disclosure, the assistance communication device precodes the incident beam based on the precoding information sent by the network-side device, which has lower complexity and higher applicability.

FIG. 2 is a schematic flowchart of a precoding method provided by an embodiment of the present disclosure. The method is executed by an assistance communication device. The assistance communication device may be a smart repeater. As shown in FIG. 2, the precoding method may include the following steps 201-202.

At step 201, precoding information sent by the network-side device is obtained.

At step 202, a composite beam is determined based on the precoding information, and the composite beam is emitted.

In an embodiment of the present disclosure, specifically, a target vector may be determined based on a specific PMI and/or a weighting coefficient set for the specific PMI. In addition, the detailed description of the steps 201-202 may refer to the description of the above embodiments, which will not be repeated here in the embodiment of the present disclosure.

In the embodiment of the present disclosure, the step 202 may specifically include: determining a target vector based on the precoding information, forming the composite beam by reflecting and/or transilluminating the incident beam based on the target vector, and emitting the composite beam.

In summary, in the precoding method provided by the embodiment of the present disclosure, the assistance communication device obtains the precoding information sent by the network-side device, then precodes the incident beam based on the precoding information to form the composite beam, and emits the composite beam. Therefore, in the embodiment of the present disclosure, the assistance communication device precodes the incident beam based on the precoding information sent by the network-side device, which has lower complexity and higher applicability.

FIG. 3 is a schematic flowchart of a precoding method provided by an embodiment of the present disclosure. The method is executed by an assistance communication device. The assistance communication device is an RIS. As shown in FIG. 3, the precoding method may include the following steps 301-303.

At step 301, precoding information sent by the network-side device is obtained.

At step 302, incident angle information of an incident beam sent by the network-side device is obtained.

At step 303, a composite beam is determined based on the precoding information and the incident angle information, and the composite beam is emitted to UE.

In an embodiment of the present disclosure, specifically, a target phase angle offset may be determined based on a specific PMI and/or a weighting coefficient set for the specific PMI. In addition, the detailed description of the steps 301-302 may refer to the description of the above embodiments, which will not be repeated here in the embodiment of the present disclosure.

In an embodiment of the present disclosure, the step 303 may specifically include: determining, based on the precoding information and the incident angle information, a target phase angle offset, determining a target phase shift matrix based on the target phase angle offset, forming the composite beam by reflecting and/or transilluminating the incident beam based on the target phase shift matrix, and emitting the composite beam.

In summary, in the precoding method provided by the embodiment of the present disclosure, the assistance communication device obtains the precoding information sent by the network-side device, then precodes the incident beam based on the precoding information to form the composite beam, and emits the composite beam. Therefore, in the embodiment of the present disclosure, the assistance communication device precodes the incident beam based on the precoding information sent by the network-side device, which has lower complexity and higher applicability.

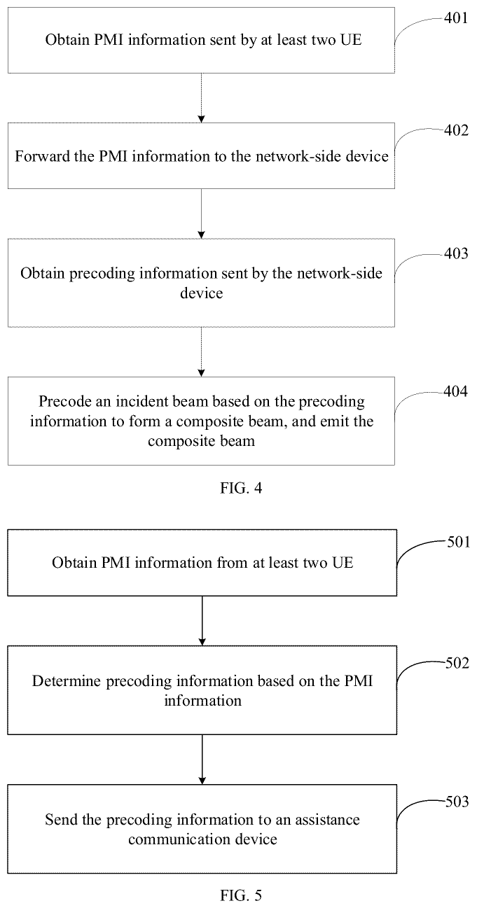

FIG. 4 is a schematic flowchart of a precoding method provided by an embodiment of the present disclosure. The method is executed by an assistance communication device. The assistance communication device is a smart repeater or an RIS. As shown in FIG. 4, the precoding method may include the following steps 401-404.

At step 401, PMI information sent by at least two UE is obtained.

In an embodiment of the present disclosure, the PMI information may include at least one PMI sent by the UE, a weighting coefficient corresponding to each PMI sent by the UE and the UE, where the at least one PMI may include M PMIs with best channel quality and/or N PMIs with worst channel quality corresponding to the UE, where M and N are integers greater than or equal to 0.

At step 402, the PMI information is forwarded to the network-side device.

At step 403, precoding information sent by the network-side device is obtained.

At step 404, based on the precoding information, an incident beam is precoded to form a composite beam, and the composite beam is emitted.

The detailed description of the steps 401-404 may refer to the description of the above embodiments, which will not be repeated here in the embodiment of the present disclosure.

In summary, in the precoding method provided by the embodiment of the present disclosure, the assistance communication device obtains the precoding information sent by the network-side device, then precodes the incident beam based on the precoding information to form the composite beam, and emits the composite beam. Therefore, in the embodiment of the present disclosure, the assistance communication device precodes the incident beam based on the precoding information sent by the network-side device, which has lower complexity and higher applicability.

FIG. 5 is a schematic flowchart of a precoding method provided by an embodiment of the present disclosure. The method is executed by a network-side device. As shown in FIG. 5, the precoding method may include the following steps 501-503.

At step 501, PMI information is obtained from at least two UE.

In an embodiment of the present disclosure, there may be a plurality of pieces of the PMI information, where the plurality of pieces of the PMI information may correspond to two or more UE, where one UE may correspond to one or more pieces of the PMI information. In an embodiment of the present disclosure, the PMI information of the at least two UE includes PMIs sent by the at least two UE. Further, the PMI information of the at least two UE may further include a weighting coefficient corresponding to each of the PMIs and each of the at least two UE. The PMIs include M PMIs with best channel quality and/or N PMIs with worst channel quality corresponding to the UE, where M and N are integers greater than or equal to 0. In addition, the weighting coefficient corresponding to the PMI is positively correlated with a bias degree of a composite beam, obtained by precoding the incident beam with the PMI, relative to the UE. For example, a precoding codebook includes N precoding matrices; the UE calculates an optimal beam precoding matrix W, and approximates the optimal beam precoding matrix W by using a linear combination of X precoding matrices in the codebook, where the weighting coefficient is a weighting coefficient of the linear combination. In a possible example, it is assumed that there are 10 candidate precoding matrices (X=10), and the optimal beam precoding matrix calculated by the UE is not in the candidate precoding matrices. Therefore, all or a part of the 10 candidate precoding matrices (several candidate precoding matrices closer to the optimal beam precoding matrix) may be used for approximation, to determine weighting coefficients of the candidate precoding matrices; that is, the closer a candidate precoding matrix approximates the optimal beam precoding matrix, and the higher a weighting coefficient of the candidate precoding matrix is.

In an embodiment of the present disclosure, the PMI information of the at least two UE may be sent by the at least two UE to the network-side device, or may be sent by the at least two UE to the network-side device via the assistance communication device.

At step 502, precoding information is determined based on the PMI information.

In an embodiment of the present disclosure, determining the precoding information based on the PMI information may include:
determining at least one specific PMI from all PMIs, determining, based on one or more weighting coefficients corresponding to the at least one specific PMI, a weighting coefficient set for each of the at least one specific PMI, and determining the at least one specific PMI and/or the weighting coefficient set for each of the at least one specific PMI as the precoding information. The weighting coefficient set includes at least one weighting coefficient, and the weighting coefficient set for the each specific PMI is determined by at least one weighting coefficient corresponding to the each specific PMI and at least one UE.

At step 503, the precoding information is sent to an assistance communication device.

The detailed description of the steps 501-503 may refer to the description of the above embodiments, which will not be repeated here in the embodiment of the present disclosure.

In the embodiment of the present disclosure, the precoding information may be determined by the network-side device according to the PMI information of the at least two UE.

That is, the precoding information may be determined by the following steps.

At step a, the network-side device obtains PMI information from each UE.

In an embodiment of the present disclosure, there may be a plurality of pieces of the PMI information, where the plurality of pieces of the PMI information may correspond to two or more UE, where one UE may correspond to one or more pieces of the PMI information. In an embodiment of the present disclosure, the PMI information of the at least two UE includes PMIs sent by the at least two UE. Further, the PMI information of the at least two UE may further include a weighting coefficient corresponding to each of the PMIs and each of the at least two UE. The PMIs include M PMIs with best channel quality and/or N PMIs with worst channel quality corresponding to the UE, where M and N are integers greater than or equal to 0. In addition, the weighting coefficient corresponding to the PMI is positively correlated with a bias degree of a composite beam, obtained by precoding the incident beam with the PMI, relative to the UE. For example, a precoding codebook includes N precoding matrices; the UE calculates an optimal beam precoding matrix W, and approximates the optimal beam precoding matrix W by using a linear combination of X precoding matrices in the codebook, where the weighting coefficient is a weighting coefficient of the linear combination. In a possible example, it is assumed that there are 10 candidate precoding matrices (X=10), and the optimal beam precoding matrix calculated by the UE is not in the candidate precoding matrices. Therefore, all or a part of the 10 candidate precoding matrices (several candidate precoding matrices closer to the optimal beam precoding matrix) may be used for approximation, to determine weighting coefficients of the candidate precoding matrices; that is, the closer a candidate precoding matrix approximates the optimal beam precoding matrix, and the higher a weighting coefficient of the candidate precoding matrix is.

In addition, in an embodiment of the present disclosure, the above PMI information may be directly sent by the UE to the network-side device; in another embodiment of the present disclosure, the above PMI information may be forwarded by the assistance communication device from the UE to the network-side device, that is, the UE first sends the PMI information to the assistance communication device, and then the assistance communication device forwards the PMI information to the network-side device. In the embodiment of the present disclosure, the assistance communication device may be for example a smart repeater/RIS.

In addition, in an embodiment of the present disclosure, when the UE sends the PMIs in the PMI information, the UE may sequentially send the PMIs in a specific order. In an embodiment of the present disclosure, the specific order may be an order of the PMIs from small to large. In another embodiment of the present disclosure, the specific order may be an order of channel quality corresponding to the PMIs from best to worst. In yet another embodiment of the present disclosure, the specific order may be an order of the channel quality corresponding to the PMIs from worst to best. Certainly, the PMI information sent by the UE may include one or more PMIs. If the UE sends only one PMI, there is no need to order the PMI; and if the UE sends a plurality of PMIs, the UE may order the PMIs in the above manner or any possible manner. Specific details may refer to examples in the above embodiments.

It should be further noted that in an embodiment of the present disclosure, the above weighting coefficient corresponding to the PMI and the above weighting coefficient corresponding to the UE are optional options, that is, the UE may send each PMI sent by the UE, the weighting coefficient corresponding to each PMI of the UE, and the weighting coefficient corresponding to the UE to the network-side device; or the UE may not send the weighting coefficient corresponding to each PMI of the UE and the weighting coefficient corresponding to the UE to the network-side device, but only send the PMIs to the network-side device. As described above, the weighting coefficient corresponding to each PMI of the UE and the UE, that is, the weighting coefficient corresponding to the PMI, is positively correlated with the bias degree of the composite beam, obtained by precoding the incident beam with the PMI, relative to the UE corresponding to the PMI.

At step b, the network-side device determines the above precoding information based on the PMI information from each UE.

In an embodiment of the present disclosure, the precoding information may be determined as follows. The network-side device selects at least one specific PMI from all PMIs corresponding to the obtained PMI information sent by the at least two UE, and determines a weighting coefficient set for each of the at least one specific PMI based on one or more weighting coefficients corresponding to the at least one specific PMI; and then, the network-side device determines the at least one specific PMI and/or the weighting coefficient set for each of the at least one specific PMI as the precoding information. The weighting coefficient set includes at least one weighting coefficient, and the weighting coefficient set for the each specific PMI is determined by at least one weighting coefficient corresponding to the each specific PMI and at least one UE. In the embodiment of the present disclosure, for each PMI, different UE corresponds to different weighting coefficients; and a weighting coefficient set for the PMI may be generated according to weighting coefficients corresponding to all or a part of the UE.

In an embodiment of the present disclosure, when selecting a specific PMI, the specific PMI is mainly determined based on target UE corresponding to the assistance communication device, where the target UE is UE that is to receive a composite beam obtained after the assistance communication device reflects and/or transilluminates an incident beam. In addition, the selected specific PMI should satisfy the following condition that after the incident beam is precoded by using the specific PMI to obtain the composite beam, the composite beam can be accurately received by the target UE.

Based on this, the specific PMI may include at least one of:
at least one PMI with best channel quality corresponding to the target UE; or
at least one PMI with worst channel quality corresponding to non-target UE.

In an embodiment of the present disclosure, after a specific PMI is determined, weighting coefficients of all UE corresponding to the specific PMI may be directly determined as a weighting coefficient set of the specific PMI. In another embodiment of the present disclosure, after the specific PMI is determined, the network-side device may further change the weighting coefficient corresponding to the specific PMI, and determine the changed weighting coefficient as the weighting coefficient set of the specific PMI. Specific details may refer to examples in the above embodiments.

It should be noted that in an embodiment of the present disclosure, when sending the precoding information to the assistance communication device, the network-side device may optionally send a weighting coefficient set for a specific PMI or weighting coefficient sets corresponding to a part of specific PMIs to the assistance communication device; that is, the network-side device may send the weighting coefficient set for each specific PMI to the assistance communication device, or the network-side device may not send the weighting coefficient set for each specific PMI to the assistance communication device, but only send one specific PMI or several specific PMIs.

In summary, in the precoding method provided by the embodiment of the present disclosure, the assistance communication device obtains the precoding information sent by the network-side device, then precodes the incident beam based on the precoding information to form the composite beam, and emits the composite beam. Therefore, in the embodiment of the present disclosure, the assistance communication device precodes the incident beam based on the precoding information sent by the network-side device, which has lower complexity and higher applicability.

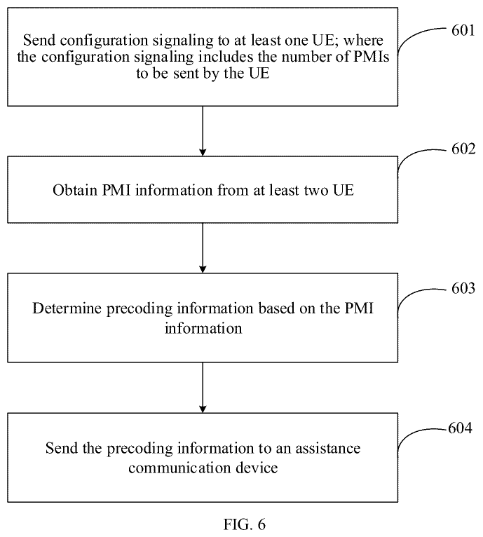

FIG. 6 is a schematic flowchart of a precoding method provided by an embodiment of the present disclosure. The method is executed by a network-side device. As shown in FIG. 6, the precoding method may include the following steps 601-604.

At step 601, configuration signaling is sent to at least one UE; where the configuration signaling includes the number of PMIs to be sent by the UE.

In an embodiment of the present disclosure, the number of PMIs sent by the UE to the network-side device may be configured by a base station.

At step 602, PMI information is obtained from at least two UE.

In an embodiment of the present disclosure, there may be a plurality of pieces of the PMI information, where the plurality of pieces of PMI information may correspond to two or more UE, where one UE may correspond to one or more pieces of the PMI information. In an embodiment of the present disclosure, the PMI information of the at least two UE includes PMIs sent by the at least two UE. Further, the PMI information of the at least two UE may further include a weighting coefficient corresponding to each of the PMIs and each of the at least two UE. The PMIs include M PMIs with best channel quality and/or N PMIs with worst channel quality corresponding to the UE, where M and N are integers greater than or equal to 0. In addition, the weighting coefficient corresponding to the PMI is positively correlated with a bias degree of a composite beam, obtained by precoding the incident beam with the PMI, relative to the UE. For example, a precoding codebook includes N precoding matrices; the UE calculates an optimal beam precoding matrix W, and approximates the optimal beam precoding matrix W by using a linear combination of X precoding matrices in the codebook, where the weighting coefficient is a weighting coefficient of the linear combination. In a possible example, it is assumed that there are 10 candidate precoding matrices (X=10), and the optimal beam precoding matrix calculated by the UE is not in the candidate precoding matrices. Therefore, all or a part of the 10 candidate precoding matrices (several candidate precoding matrices closer to the optimal beam precoding matrix) may be used for approximation, to determine weighting coefficients of the candidate precoding matrices; that is, the closer a candidate precoding matrix approximates the optimal beam precoding matrix, and the higher a weighting coefficient of the candidate precoding matrix is.

It should be noted that in an embodiment of the present disclosure, the number of PMIs included in the above PMI information should be the same as the number configured in the configuration signaling in the step 601.

In the embodiment of the present disclosure, the configuration signaling may be sent to a part of UE to indicate the number of PMIs to be sent by the UE; while the other UE may determine the number of PMIs to be sent by the UE according to a communication protocol. In the embodiment of the present disclosure, the configuration signaling may be sent to all UE to indicate the number of PMIs to be sent by the UE. Those skilled in the art can understand that specific configuration signaling may be sent to the UE to configure the number of PMIs to be sent by the UE, that is, the number of PMIs to be sent corresponding to different UE may be the same or different. Alternatively, the configuration signaling may be sent to all UE to configure the same number of PMIs.

Further, in an embodiment of the present disclosure, obtaining the PMI information from at least two UE may include at least one of the following.

In a first method, the PMI information sent by the at least two UE is obtained.

In a second method, the PMI information of the at least two UE forwarded by the assistance communication device is obtained.

At step 603, precoding information is determined based on the PMI information.

At step 604, the precoding information is sent to an assistance communication device.

The detailed description of the steps 601-604 may refer to the description of the above embodiments, which will not be repeated here in the embodiment of the present disclosure.

In summary, in the precoding method provided by the embodiment of the present disclosure, the assistance communication device obtains the precoding information sent by the network-side device, then precodes the incident beam based on the precoding information to form the composite beam, and emits the composite beam. Therefore, in the embodiment of the present disclosure, the assistance communication device precodes the incident beam based on the precoding information sent by the network-side device, which has lower complexity and higher applicability.

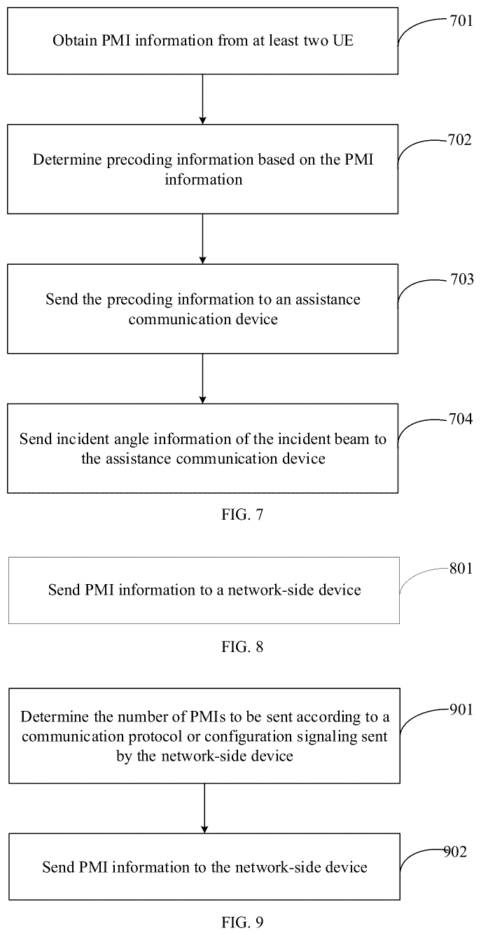

FIG. 7 is a schematic flowchart of a precoding method provided by an embodiment of the present disclosure. The method is executed by a network-side device. As shown in FIG. 7, the precoding method may include the following steps 701-704.

At step 701, PMI information is obtained from at least two UE.

At step 702, precoding information is determined based on the PMI information.

At step 703, the precoding information is sent to an assistance communication device.

At step 704, incident angle information of the incident beam is sent to the assistance communication device.

The detailed description of the steps 701-704 may refer to the description of the above embodiments, which will not be repeated here in the embodiment of the present disclosure.

In summary, in the precoding method provided by the embodiment of the present disclosure, the assistance communication device obtains the precoding information sent by the network-side device, then precodes the incident beam based on the precoding information to form the composite beam, and emits the composite beam. Therefore, in the embodiment of the present disclosure, the assistance communication device precodes the incident beam based on the precoding information sent by the network-side device, which has lower complexity and higher applicability.

FIG. 8 is a schematic flowchart of a precoding method provided by an embodiment of the present disclosure. The method is executed by UE. As shown in FIG. 8, the precoding method may include the following step 801.

At step 801, PMI information is sent to a network-side device.

In an embodiment of the present disclosure, the UE may be a device providing voice and/or data connectivity to a user. The UE may communicate with one or more core networks through a radio access network (RAN). The UE may be an Internet of Things terminal, such as a sensor device, a mobile phone (or referred to as a “cellular” phone), and a computer having the Internet of Things terminal, for example a fixed, portable, pocket, handheld, computer built-in, or vehicle-mounted apparatus. For example, The UE may be a station (STA), a subscriber unit, a subscriber station, a mobile station, a mobile table, a remote station, an access point, a remote terminal, an access terminal, a user terminal, or a user agent. Alternatively, the UE may be a device of an unmanned aerial vehicle. Alternatively, the UE may be a vehicle-mounted device, for example, a vehicle computer having a wireless communication function, or a wireless terminal externally connected to a vehicle computer. Alternatively, the UE may also be a roadside device, for example, a street lamp, a signal light, other roadside device, etc., having a wireless communication function.

In an embodiment of the present disclosure, the PMI information includes at least one of:
one or more PMIs sent by the UE, where the one or more PMIs include M PMIs with best channel quality and/or N PMIs with worst channel quality corresponding to the UE, where M and N are integers greater than or equal to 0; or
a weighting coefficient corresponding to each of the PMIs and each of the at least two UE.

In addition, in an embodiment of the present disclosure, sending the PMI information to the network-side device may include at least one of the following.

In a first method, the PMI information is directly sent to the network-side device.

In a second method, the PMI information is sent to the network-side device through an assistance communication device.

The other detailed description of the step 801 may refer to the description of the above embodiments, which will not be repeated here in the embodiment of the present disclosure.

In summary, in the precoding method provided by the embodiment of the present disclosure, the assistance communication device obtains the precoding information sent by the network-side device, then precodes the incident beam based on the precoding information to form the composite beam, and emits the composite beam. Therefore, in the embodiment of the present disclosure, the assistance communication device precodes the incident beam based on the precoding information sent by the network-side device, which has lower complexity and higher applicability.

FIG. 9 is a schematic flowchart of a precoding method provided by an embodiment of the present disclosure. The method is executed by UE. As shown in FIG. 9, the precoding method may include the following steps 901-902.

At step 901, the number of PMIs to be sent is determined according to a communication protocol or configuration signaling sent by the network-side device.

At step 902, PMI information is sent to a network-side device.

The detailed description of the steps 901-902 may refer to the description of the above embodiments, which will not be repeated here in the embodiment of the present disclosure.

In summary, in the precoding method provided by the embodiment of the present disclosure, the assistance communication device obtains the precoding information sent by the network-side device, then precodes the incident beam based on the precoding information to form the composite beam, and emits the composite beam. Therefore, in the embodiment of the present disclosure, the assistance communication device precodes the incident beam based on the precoding information sent by the network-side device, which has lower complexity and higher applicability.

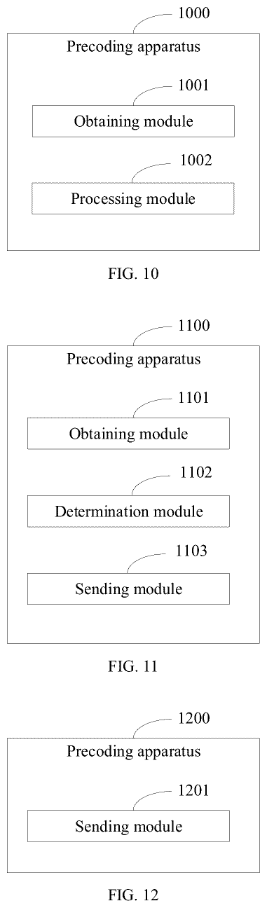

FIG. 10 is a structural diagram of a precoding apparatus provided by an embodiment of the present disclosure, which is configured in an assistance communication device. As shown in FIG. 10, the precoding apparatus 1000 may include:
an obtaining module 1001, configured to obtain precoding information sent by a network-side device; and
a processing module 1002, configured to precode, based on the precoding information, an incident beam to form a composite beam, and emit the composite beam.

In summary, in the precoding apparatus provided by the embodiment of the present disclosure, the assistance communication device obtains the precoding information sent by the network-side device, then precodes the incident beam based on the precoding information to form the composite beam, and emits the composite beam. Therefore, in the embodiment of the present disclosure, a precoding method is provided, in which the beam reflected at the assistance communication device is precoded by using a plurality of PMIs, to ensure that the complexity of the precoding is reduced.

Optionally, in an embodiment of the present disclosure, the precoding information includes at least one of:
at least one specific PMI; or
a weighting coefficient set for each of the at least one specific PMI; where the weighting coefficient set for each of the at least one specific PMI includes at least one weighting coefficient and is determined by at least one weighting coefficient corresponding to the each specific PMI and at least one UE.

Optionally, in an embodiment of the present disclosure, the assistance communication device is a smart repeater.

Optionally, in an embodiment of the present disclosure, the processing module is further configured to:
determine a target vector based on the precoding information, and form the composite beam by reflecting and/or transilluminating the incident beam based on the target vector.

Optionally, in an embodiment of the present disclosure, the assistance communication device is an RIS.

Optionally, in an embodiment of the present disclosure, the apparatus is further configured to:
obtain incident angle information of the incident beam sent by the network-side device.

Optionally, in an embodiment of the present disclosure, the processing module is further configured to:
determine, based on the precoding information and the incident angle information, a target phase angle offset, determine a target phase shift matrix based on the target phase angle offset, and form the composite beam by reflecting and/or transilluminating the incident beam based on the target phase shift matrix.

Optionally, in an embodiment of the present disclosure, the apparatus is further configured to:
obtain PMI information sent by at least two UE; where there are a plurality of pieces of the PMI information, and the plurality of pieces of the PMI information correspond to two or more UE, where one UE corresponds to one or more pieces of the PMI information; and the PMI information of the at least two UE includes at least one of: PMIs sent by the at least two UE, or a weighting coefficient corresponding to each of the PMIs and each of the at least two UE; where the PMIs corresponding to the UE include M PMIs with best channel quality and/or N PMIs with worst channel quality, where M and N are integers greater than or equal to 0; and
forward the PMI information to the network-side device.

FIG. 11 is a structural diagram of a precoding apparatus provided by an embodiment of the present disclosure, which is configured in a network-side device. As shown in FIG. 11, the precoding apparatus 1100 may include:
an obtaining module 1101, configured to obtain PMI information from at least two UE;
a determination module 1102, configured to determine precoding information based on the PMI information; and
a sending module 1103, configured to send the precoding information to an assistance communication device.

In summary, in the precoding apparatus provided by the embodiment of the present disclosure, the assistance communication device obtains the precoding information sent by the network-side device, then precodes the incident beam based on the precoding information to form the composite beam, and emits the composite beam. Therefore, in the embodiment of the present disclosure, a precoding method is provided, in which the beam reflected at the assistance communication device is precoded by using a plurality of PMIs, to ensure that the complexity of the precoding is reduced.

Optionally, in an embodiment of the present disclosure, there are a plurality of pieces of the PMI information, and the plurality of pieces of the PMI information correspond to two or more UE, where one UE corresponds to one or more pieces of the PMI information; and the PMI information of the at least two UE includes at least one of: PMIs sent by the at least two UE, or a weighting coefficient corresponding to each of the PMIs and each of the at least two UE; where the PMIs corresponding to the UE include M PMIs with best channel quality and/or N PMIs with worst channel quality, where M and N are integers greater than or equal to 0.

Optionally, in an embodiment of the present disclosure, the apparatus is further configured to:
send configuration signaling to at least one UE; where the configuration signaling includes the number of PMIs to be sent by the UE.

Optionally, in an embodiment of the present disclosure, the obtaining module is further configured to:
obtain the PMI information sent by the at least two UE; or
obtain the PMI information of the at least two UE forwarded by the assistance communication device.

Optionally, in an embodiment of the present disclosure, the determination module is further configured to:
select at least one specific PMI from all PMIs corresponding to obtained PMI information sent by the at least two UE, and determine, based on one or more weighting coefficients corresponding to the at least one specific PMI, a weighting coefficient set for each of the at least one specific PMI; where the weighting coefficient set for each of the at least one specific PMI includes at least one weighting coefficient and is determined by at least one weighting coefficient corresponding to the each specific PMI and at least one UE; and
determine the at least one specific PMI and/or the weighting coefficient set for each of the at least one specific PMI as the precoding information.

Optionally, in an embodiment of the present disclosure, the apparatus is further configured to:
send incident angle information of an incident beam to the assistance communication device.

FIG. 12 is a structural diagram of a precoding apparatus provided by an embodiment of the present disclosure, which is configured in UE. As shown in FIG. 12, the precoding apparatus 1200 may include:
a sending module 1201, configured to send PMI information to a network-side device.

In summary, in the precoding apparatus provided by the embodiment of the present disclosure, the assistance communication device obtains the precoding information sent by the network-side device, then precodes the incident beam based on the precoding information to form the composite beam, and emits the composite beam. Therefore, in the embodiment of the present disclosure, a precoding method is provided, in which the beam reflected at the assistance communication device is precoded by using a plurality of PMIs, to ensure that the complexity of the precoding is reduced.

Optionally, in an embodiment of the present disclosure, the PMI information includes at least one of:
one or more PMIs sent by the UE, where the one or more PMIs include M PMIs with best channel quality and/or N PMIs with worst channel quality corresponding to the UE, where M and N are integers greater than or equal to 0; or

a weighting coefficient corresponding to each of the PMIs and each of the at least two UE.

Optionally, in an embodiment of the present disclosure, the apparatus is further configured to:
determine the number of PMIs to be sent according to a communication protocol or configuration signaling sent by the network-side device.

Optionally, in an embodiment of the present disclosure, the sending module is further configured to:
directly send the PMI information to the network-side device; or
send the PMI information to the network-side device through an assistance communication device.

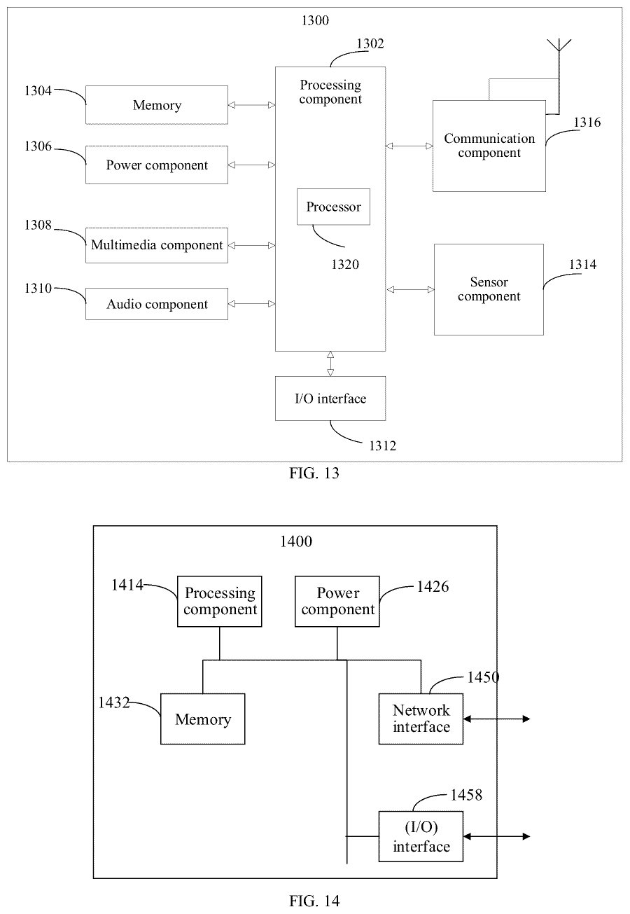

FIG. 13 is a block diagram of user equipment (UE) 1300 provided by an embodiment of the present disclosure. For example, the UE 1300 may be a mobile phone, a computer, a digital broadcast terminal device, a message transceiving device, a game console, a tablet device, a medical device, a fitness device, a personal digital assistant, etc.

Referring to FIG. 13, the UE 1300 may include at least one of the following components: a processing component 1302, a memory 1304, a power component 1306, a multimedia component 1308, an audio component 1310, an input/output (I/O) interface 1312, a sensor component 1314, and a communication component 1316.

The processing component 1302 typically controls the overall operation of the UE 1300, such as operations associated with display, phone calls, data communication, camera operations, and recording operations. The processing component 1302 may include at least one processor 1320 to execute instructions to complete all or part of the steps in the above methods. Additionally, the processing component 1302 may include at least one module to facilitate interaction between the processing component 1302 and other components. For example, the processing component 1302 may include a multimedia module to facilitate interaction between the multimedia component 1308 and the processing component 1302.

The memory 1304 is configured to store various types of data to support operations of the UE 1300. Examples of such data include instructions, contact data, phonebook data, messages, pictures, videos, etc., for any application program or method operating on the UE 1300. The memory 1304 may be realized by any type of volatile or non-volatile storage device or their combination, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

The power component 1306 provides power to various components of the UE 1300. The power component 1306 may include a power supply management system, at least one power supply, and other components that are associated with generating, managing, and distributing power for the UE 1300.

The multimedia component 1308 includes a screen providing an output interface between the UE 1300 and the user. In some embodiments, the screen may include a liquid crystal display (LCD) and a touch panel (TP). If the screen includes the touch panel, the screen may be implemented as a touch screen, to receive an input signal from the user. The touch panel includes at least one touch sensor to sense the touch, the slide, and the gesture on the touch panel. The touch sensor may not only sense a boundary of the touch or slide action, but also detect a wake-up time and pressure related to the touch or slide operation. In some embodiments, the multimedia component 1308 includes a front facing camera and/or a rear facing camera. When the UE 1300 is in an operation mode, such as a shooting mode or a video mode, the front facing camera and/or the rear facing camera may receive external multimedia data. Each of the front facing camera and rear facing camera can be a fixed optical lens system or has a focal length and an optical zoom capability.

The audio component 1310 is configured to output and/or input audio signals. For example, the audio component 1310 includes a microphone (MIC). The microphone is configured to receive external audio signals when the UE 1300 is in the operating mode, such as a call mode, a recording mode, and a speech recognition mode. The received audio signals may be further stored in the memory 1304 or sent via the communication component 1316. In some embodiments, the audio component 1310 also includes a speaker for outputting the audio signals.

The I/O interface 1312 provides an interface between the processing component 1302 and peripheral interface modules. The peripheral interface modules may be keyboards, click wheels, buttons, etc. These buttons may include but are not limited to: a home button, a volume button, a start button, and a lock button.

The sensor component 1314 includes at least one sensor to provide various aspects of state assessment for the UE 1300. For example, the sensor component 1314 may detect an open/closed state of the UE 1300, relative positioning of components that are for example a display and keypad of the UE 1300. The sensor component 1314 may also detect a position change of the UE 1300 or of a component of the UE 1300, presence or absence of the user contacting with the UE 1300, an orientation or acceleration/deceleration of the UE 1300, and a temperature change of the UE 1300. The sensor component 1314 may include a proximity sensor configured to detect the presence of nearby objects without any physical contact. The sensor component 1314 may also include a light sensor, such as a CMOS or CCD image sensor, for use in an imaging application. In some embodiments, the sensor component 1314 may also include an acceleration sensor, a gyroscope sensor, a magnetic sensor, a pressure sensor, or a temperature sensor.

The communication component 1316 is configured to facilitate wired or wireless communication between the UE 1300 and other devices. The UE 1300 may access a wireless network based on a communication standard, such as WiFi, 2G, 3G, or a combination of them. In an exemplary embodiment, the communication component 1316 receives, via a broadcast channel, a broadcast signal or broadcast related information from an external broadcast management system. In an exemplary embodiment, the communication component 1316 further includes a near-field communication (NFC) module to facilitate short-range communication. For example, the NFC module may be implemented based on a radio frequency identification (RFID) technology, an infrared data association (IrDA) technology, an ultra-wideband (UWB) technology, a Bluetooth (BT) technology, and other technologies.

In an exemplary embodiment, the UE 1300 may be implemented by at least one application specific integrated circuit (ASIC), digital signal processor (DSP), digital signal processing device (DSPD), programmable logic device (PLD), field programmable gate array (FPGA), controller, microcontroller, microprocessors, or other electronic component to execute the above methods.

FIG. 14 is a block diagram of a network-side device 1400 provided by an embodiment of the present disclosure. For example, the network-side device 1400 may be provided as one network-side device. Referring to FIG. 14, the network-side device 1400 includes a processing component 1414 that further includes at least one processor, and memory resources represented by a memory 1432, to store instructions that is executable by the processing component 1414, such as an application program. The application program stored in the memory 1432 may include one or more modules that each corresponds to a set of instructions. In addition, the processing component 1414 is configured to execute instructions to execute any method applied to the network-side device in the above methods, for example, the method shown in FIG. 1.

The network-side device 1400 may also include a power component 1426 configured to execute power management of the network-side device 1400, a wired or wireless network interface 1450 configured to connect the network-side device 1400 to the network, and an input/output (I/O) interface 1458. The network-side device 1400 may operate an operating system stored in the memory 1432, such as Windows Server™, Mac OS X™, Unix™, Linux™, Free BSD™, or a similar operating system.

In the embodiments provided by the present disclosure, the methods provided by the embodiments of the present disclosure is introduced respectively from the perspectives of the network-side device and the UE. To implement various functions in the methods provided in the embodiments of the present disclosure, the network-side device and the UE may include a hardware structure and a software module, to implement the functions in a form of the hardware structure, the software module, or a combination of the hardware structure and the software module. A certain function in the above functions may be executed by using a hardware structure, a software module, or a combination of the hardware structure and the software module.

In the embodiments provided by the present disclosure, the methods provided by the embodiments of the present disclosure is introduced respectively from the perspectives of the network-side device and the UE. To implement various functions in the methods provided in the embodiments of the present disclosure, the network-side device and the UE may include a hardware structure and a software module, to implement the functions in a form of the hardware structure, the software module, or a combination of the hardware structure and the software module. A certain function in the above functions may be executed by using a hardware structure, a software module, or a combination of the hardware structure and the software module.

An embodiment of the present disclosure provides a communication apparatus. The communication apparatus may include a transceiving module and a processing module. The transceiving module may include a sending module and/or a receiving module. The sending module is configured to implement a sending function, the receiving module is configured to implement a receiving function, and the transceiving module may implement the sending function and/or the receiving function.

The communication apparatus may be a terminal device (for example, the terminal device in the above method embodiments), an apparatus in the terminal device, or an apparatus that can be matched with the terminal device for use. Alternatively, the communication apparatus may be a network device, an apparatus in the network device, or an apparatus that can be matched with the network device for use.

An embodiment of the present disclosure provides another communication apparatus. The communication apparatus may be a network device or a terminal device, or may be a terminal device (for example, the terminal device in the above method embodiments), or may be a chip, a chip system, or a processor that supports the network device to implement the above methods, etc., or may be a chip, a chip system, or a processor that supports the terminal device to implement the above methods. This apparatus may be configured to implement the methods described in the above method embodiments, which may specifically refer to the description in the above method embodiments.

The communication apparatus may include one or more processors. The processors may be general-purpose processors, special-purpose processors, etc. For example, the processors may be baseband processors or central processing units. The baseband processor may be used to process a communication protocol and communication data, and the central processing unit may be used to control the communication apparatus (for example, a network-side device, a baseband chip, a terminal device, a terminal device chip, a DU, a CU, etc.), execute a computer program, and process data of the computer program.

Optionally, the communication apparatus may further include one or more memories. The one or more memories may store a computer program, and the processor executes the computer program to cause the communication apparatus to execute the methods described in the above method embodiments. Optionally, the memory may further store data. The communication apparatus and the memory may be separately configured, or may be integrated together.

Optionally, the communication apparatus may further include a transceiver and an antenna. The transceiver may be referred to as a transceiving unit, a transceiving machine, a transceiving circuit, etc., and is configured to implement a transceiving function. The transceiver may include a receiver and a transmitter. The receiver may be referred to as a receiving machine, a receiving circuit, etc., and is used to implement a receiving function. The transmitter may be referred to as a transmitting machine, a transmitting circuit, etc., and is used to implement a transmitting function.

Optionally, the communication apparatus may further include one or more interface circuits. The interface circuits are used to receive code instructions and transmit the code instructions to the processor. The processor executes the code instructions to cause the communication apparatus to execute the methods described in the above method embodiments.

The communication apparatus is a terminal device (for example, the terminal device in the above method embodiments), and the processor is used to execute any method shown in FIG. 1-4.

The communication apparatus is a network device, and the transceiver is used to execute any method shown in FIGS. 5-7.

In an implementation, the processor may include a transceiver for implementing the receiving and transmitting functions. For example, the transceiver may be a transceiving circuit, an interface, or an interface circuit. The transceiving circuit, the interface, or the interface circuit for implementing the receiving and transmitting functions may be separate or integrated together. The transceiving circuit, the interface, or the interface circuit may be used to read and write codes/data, or the transceiving circuit, the interface, or the interface circuit may be used to transmit or transfer a signal.

In an implementation, the processor may store a computer program, and the computer program runs on the processor, so that the communication apparatus may execute the methods described in the above method embodiments. The computer program may be fixed in the processor, and in this situation, the processor may be implemented by hardware.

In an implementation, the communication apparatus may include a circuit, and the circuit may implement sending, receiving, or communicating functions in the above method embodiments. The processor and transceiver described in the present disclosure may be implemented on integrated circuits (ICs), analog ICs, radio frequency integrated circuits (RFICs), mixed signal ICs, application specific integrated circuits (ASICs), printed circuit boards (PCBs), electronic devices, etc. The processor and transceiver may also be fabricated with various IC process technologies, such as a complementary metal oxide semiconductor (CMOS), an n-metal oxide semiconductor (NMOS), a p-metal oxide semiconductor (positive channel metal oxide semiconductor, PMOS), a bipolar junction transistor (BJT), a bipolar CMOS (BiCMOS), a silicon germanium (SiGe), a gallium arsenide (GaAs), etc.

The communication apparatus described in the above embodiments may be a network device or a terminal device (for example, the terminal device in the above method embodiments), but a scope of the communication apparatus described in the present disclosure is not limited thereto, and a structure of the communication apparatus may not be limited. The communication apparatus may be a separate device or may be a part of a larger device. For example, the communication apparatus may be:
(1) a separate integrated circuit IC, chip, or chip system or subsystem;
(2) a set of one or more ICs; optionally, the set of ICs may also include a storage component for storing data and a computer program;
(3) an ASIC, for example, a modem;
(4) a module that may be embedded within other devices;
(5) a receiving machine, a terminal device, an intelligent terminal device, a cellular phone, a wireless device, a handset, a mobile unit, an in-vehicle device, a network device, a cloud device, an artificial intelligence device, etc.; or
(6) other apparatus, etc.

In the case that the communication apparatus may be a chip or a chip system, the chip includes a processor and an interface. There may be one or more processors, and there may be a plurality of interfaces.

Optionally, the chip further includes a memory, and the memory is used to store a necessary computer program and data.

Those skilled in the art may also understand that various illustrative logical blocks and steps listed in the embodiments of the present disclosure may be implemented by using electronic hardware, computer software, or a combination of the two. Whether such function is implemented by hardware or software depends on specific applications and design requirements of an overall system. Those skilled in the art may use various methods to implement the functions for each specific application, but this implementation should not be understood as going beyond the protection scope of the embodiments of the present disclosure.

The present disclosure further provides a readable storage medium storing instructions. When the instructions are executed by a computer, functions of any one of the above method embodiments are implemented.

The present disclosure further provides a computer program product. When the computer program product is executed by a computer, the functions of any one of the above method embodiments are implemented.

In the above embodiments, it may be implemented in whole or in part by software, hardware, firmware, or any combination thereof. When implemented in software, it may be implemented in whole or in part in the form of a computer program product. The computer program product includes one or more computer programs. When the computer programs are loaded and executed by a computer, the processes or functions according to embodiments of the present disclosure are generated in whole or in part. The computer may be a general purpose computer, a special purpose computer, a computer network, or other programmable apparatus. The computer programs may be stored in a computer readable storage medium or transmitted from one computer readable storage medium to another computer readable storage medium. For example, the computer programs may be transmitted from a website site, computer, server or data center to another website site, computer, server or data center by a wired (for example, a coaxial-cable, a fiber, a digital subscriber line (DSL)) or wirelessly (for example, infrared, wireless, microwave, etc.) manner. The computer readable storage medium may be any available medium that can be accessed by a computer or may be a data storage device, such as a server, data center, or the like, including one or more integrated available mediums. The available medium may be a magnetic medium (for example, a floppy disk, a hard disk, a magnetic tape), an optical medium (for example, a digital video disc (DVD)), or a semiconductor medium (for example, a solid state disk (SSD)), etc.

Those skilled in the art may understand that various numerical numbers such as “first” and “second” involved in the present disclosure are only for distinguishing for the convenience of description and are not intended to limit the scope of the embodiments of the present disclosure, and do not also represent an early-later sequence.

“At least one” in the present disclosure may also be described as one or more, and “a plurality of/multiple” may be two, three, four or more, which is not limited in the present disclosure. In the embodiments of the present disclosure, for a kind of technical features, technical features in the kind of technical features are distinguished by “first”, “second”, “third”, “A”, “B”, “C”, and “D”, etc., and there is no an early-later sequence or a large-small sequence among the technical features described by “first”, “second”, “third”, “A”, “B”, “C”, and “D”.

Those skilled in the art will easily come up with other implementation solutions of the present disclosure after considering the specification and practicing the present disclosure disclosed herein. The present disclosure aims to cover any variations, uses, or adaptive changes of the present disclosure, which follow general principles of the present disclosure and include common knowledge or customary technical means in the art not disclosed in the present disclosure. The specification and embodiments are only considered exemplary, and the true scope and spirit of the present disclosure are indicated by the following claims.

It should be understood that the present disclosure is not limited to the precise structure described above and shown in the accompanying drawings, and various modifications and changes may be made without departing from its scope. The scope of the present disclosure is limited only by the appended claims.

An embodiment in yet another aspect of the present disclosure provides a precoding apparatus that includes:
an obtaining module, configured to obtain precoding information sent by a network-side device; and
a processing module, configured to precode, based on the precoding information, an incident beam to form a composite beam, and emit the composite beam.

An embodiment in yet another aspect of the present disclosure provides a precoding apparatus that includes:
an obtaining module, configured to obtain PMI information from at least two UE;
a determination module, configured to determine precoding information based on the PMI information; and
a sending module, configured to send the precoding information to an assistance communication device.

An embodiment in yet another aspect of the present disclosure provides a precoding apparatus that includes:
a sending module, configured to send PMI information to a network-side device.

An embodiment in yet another aspect of the present disclosure provides a communication apparatus. The communication apparatus includes a processor and an interface circuit;
where the interface circuit is configured to receive code instructions and transmit the code instructions to the processor; and
the processor is configured to execute the code instructions to execute the method provided in the embodiment in an aspect.

An embodiment in yet another aspect of the present disclosure provides a communication apparatus. The communication apparatus includes a processor and an interface circuit;
where the interface circuit is configured to receive code instructions and transmit the code instructions to the processor; and
the processor is configured to execute the code instructions to execute the method provided in the embodiment in an aspect.

An embodiment in yet another aspect of the present disclosure provides a communication apparatus. The communication apparatus includes a processor and an interface circuit;
where the interface circuit is configured to receive code instructions and transmit the code instructions to the processor; and
the processor is configured to execute the code instructions to execute the method provided in the embodiment in another aspect.

1. A precoding method, applied to an assistance communication device, the precoding method comprising:
obtaining precoding information sent by a network-side device;
precoding, based on the precoding information, an incident beam to form a composite beam; and
emitting the composite beam.

2. The precoding method of claim 1, wherein the precoding information comprises at least one of:
at least one precoding matrix index (PMI); or
a weighting coefficient set for each of the at least one PMI; wherein the weighting coefficient set for each of the at least one PMI comprises at least one weighting coefficient and is determined by at least one weighting coefficient corresponding to the each PMI and at least one UE.

3. The precoding method of claim 2, wherein the assistance communication device is a smart repeater:
wherein the precoding, based on the precoding information, the incident beam to form the composite beam comprises:
determining a target vector based on the precoding information;
and
forming the composite beam by reflecting and/or transilluminating the incident beam based on the target vector.

4. (canceled)

5. The precoding method of claim 2, wherein the assistance communication device is a reconfigurable intelligent surface (RIS);
wherein the method further comprises:
obtaining incident angle information of the incident beam sent by the network-side device;
wherein the precoding, based on the precoding information, the incident beam to form the composite beam comprises:
determining, based on the precoding information and the incident angle information, a target phase angle offset;
determining a target phase shift matrix based on the target phase angle offset; and
forming the composite beam by reflecting and/or transilluminating the incident beam based on the target phase shift matrix.

6.-7. (canceled)

8. The precoding method of claim 1, further comprising:
obtaining PMI information sent by at least two UE; wherein there are a plurality of pieces of the PMI information corresponding to two or more UE, wherein one UE corresponds to one or more pieces of the PMI information; and the PMI information of the at least two UE comprises at least one of: PMIs sent by the at least two UE, or a weighting coefficient corresponding to each of the PMIs and each of the at least two UE; wherein the PMIs corresponding to the UE comprise M PMIs with best channel quality and/or N PMIs with worst channel quality, wherein M and N are integers greater than or equal to 0; and
forwarding the PMI information to the network-side device.

9. A precoding method, applied to a network-side device and comprising:
obtaining PMI information from at least two UE;
determining precoding information based on the PMI information; and
sending the precoding information to an assistance communication device.

10. The precoding method of claim 9, wherein there are a plurality of pieces of the PMI information corresponding to two or more UE, wherein one UE corresponds to one or more pieces of the PMI information; and the PMI information of the at least two UE comprises at least one of: PMIs sent by the at least two UE, or a weighting coefficient corresponding to each of the PMIs and each of the at least two UE; wherein the PMIs corresponding to the UE comprise M PMIs with best channel quality and/or N PMIs with worst channel quality, wherein M and N are integers greater than or equal to 0.

11. The precoding method of claim 9, further comprising:
sending configuration signaling to at least one UE; wherein the configuration signaling comprises a number of PMIs to be sent by the UE.

12. The precoding method of claim 9, wherein the obtaining PMI information from the at least two UE comprises at least one of:
obtain the PMI information sent by the at least two UE; or
obtaining the PMI information of the at least two UE forwarded by the assistance communication device.

13. The precoding method of claim 9, wherein the determining precoding information based on the PMI information comprises:
selecting at least one specific PMI from all PMIs corresponding to obtained PMI information sent by the at least two UE;
determining, based on one or more weighting coefficients corresponding to the at least one specific PMI, a weighting coefficient set for each of the at least one specific PMI; wherein the weighting coefficient set for each of the at least one specific PMI comprises at least one weighting coefficient and is determined by at least one weighting coefficient corresponding to the each specific PMI and at least one UE; and
determining the at least one specific PMI and/or the weighting coefficient set for each of the at least one specific PMI as the precoding information.

14. The precoding method of claim 9, further comprising:
sending incident angle information of an incident beam to the assistance communication device.

15. A precoding method, applied to UE and comprising:
sending PMI information to a network-side device.

16. The precoding method of claim 15, wherein the PMI information comprises at least one of:
one or more PMIs sent by the UE; wherein the one or more PMIs comprise M PMIs with best channel quality and/or N PMIs with worst channel quality corresponding to the UE, wherein M and N are integers greater than or equal to 0; or
a weighting coefficient corresponding to each of the PMIs and each of at least two UE;
wherein the method further comprises:
determining a number of PMIs to be sent, according to a communication protocol or configuration signaling sent by the network-side device.

17. (canceled)

18. The precoding method of claim 15, wherein the sending PMI information to the network-side device comprises at least one of:
directly sending the PMI information to the network-side device; or
sending the PMI information to the network-side device through an assistance communication device.

19.-21. (canceled)

22. A communication apparatus, comprising:
one or more processors; and
a memory that stores a computer program, wherein the computer program when executed by the one or more processors cause the communication apparatus to execute the precoding method of claim 1.

23. A communication apparatus, comprising:
one or more processors; and
a memory that stores a computer program, wherein the computer program when executed by the one or more processors cause the communication apparatus to execute the precoding method of claim 9.

24. A communication apparatus, comprising:
one or more processors; and
a memory that stores a computer program, wherein the computer program when executed by the one or more processors cause the communication apparatus to execute the precoding method of claim 15.

25.-27. (canceled)

28. A non-transitory computer-readable storage medium, configured to store instructions, the instructions when executed by one or more processors cause the one or more processors to collectively execute the precoding method of claim 1.

29. A non-transitory computer-readable storage medium, configured to store instructions, the instructions when executed by one or more processors cause the one or more processors to collectively execute the precoding method of claim 9.

30. A non-transitory computer-readable storage medium, configured to store instructions, the instructions when executed by one or more processor cause the one or more processors to collectively execute the method of claim 15.
